(19) United States
(12) Patent Application Publication
(10) Pub. No.: US 2008/0100037 A1
(43) Pub. Date: May 1, 2008

(54) FIELD ASSEMBLABLE TRAILER

(76) Inventors: George C. Greene III, Charleston, SC (US); George C. Greene IV, Charleston, SC (US); Harvey Dumond JR., Hudsonville, MI (US); Kevin D. Naber, Holland, MI (US); Jack G. Koedoot, Hudsonville, MI (US); Ross T. Van Klompenberg, Hudsonville, MI (US)

Correspondence Address: HAMMER & HANF, PC, 3125 SPRINGBANK LANE, SUITE G, CHARLOTTE, NC, 28226, US

(21) Appl. No.: 11/869,936

(22) Filed: Oct. 10, 2007

Related U.S. Application Data
(60) Provisional application No. 60/828,872, filed on Oct. 10, 2006.

(51) Int. Cl. B62D 63/06

(52) U.S. Cl. 280/656

(57) ABSTRACT

A field assemblable trailer that has a container having a bottom, a hitch assembly configured to be securable to the bottom of the container, an axle housing configured to be securable to the bottom of the container, a pair of hub and axle assemblies configured to be attached inside the axle housing and a pair of tires on rims configured to attached to the hubs. The hitch assembly, the axle housing, the pair of hub and axle assemblies and the tires on rims comprise a kit which fits inside the container. The kit takes up a minimal room which leaves the container free to accept a larger primary load for safe keeping. When the container is opened the kit is readily identifiable and is capable of converting the shipping container to an enclosed trailer quickly with minimal tools. This can be done while providing protection of the primary load.

### RELATED CASES

This application claims the Priority of the Provisional Application Ser. No. 60/828,872 filed Oct. 10, 2006.

### BACKGROUND OF THE INVENTION

The present invention provides the field assemblable trailer which is easy to transport and easy to assemble.

The concept of a folding trailer is known some examples include U.S. Pat. Nos. 4,758,008, 5,743,541 and 7,150,466 these trailers are usually designed to make storage or transport more convenient.

However there is still an unfulfilled need to have a fully enclosed storage or shipment container which is capable of holding a primary load for safe transport and also is capable of containing a kit which is capable of transforming the shipping container to a trailer which would insure that the primary load reaches its intended destination in tact. In emergency situations, areas of conflict, or in delivering supplies to groups living in third world countries, it is often the case that commercial transport might be able to deliver a package to a close proximity, but not all the way to the intended location. In many instances the shipper would want to provide safe transport of a primary load which would insure that supplies or parts are not lost, stolen or damaged by transport or by the unloading and reloading of the primary load in route to a remote location.

Recently the concept of packing and storing a movable, securable storage unit has been popular. The PODS (Portable On Demand Storage) storage container is a securable storage container which is configured to be loaded and unloaded from a specialized truck has proved popular. U.S. Pat. No. 6,830,422 teaches that a large load can be secured in a shipping container, then, with some specialized add-ons; provide transport to a final destination. US patent publication 2004/0207173 teaches that a smaller container can be mounted to an external apparatus which allows it to be pulled to the desired sites more easily. However neither of these inventions allows for the pieces of the transport unit to be stored in the storage container.

Finally US Patent Application Publication 2007/0120345 teaches a shipping container which can be rearranged into a trailer, but requires that the primary package be removed and the pieces of the shipping container be taken apart and rearranged into a trailer.

While the prior art provides containers that can be converted into trailers and foldable trailers, nothing teaches a shipping container which is capable of fully enclosing a primary load and a secondary trailer kit for safe transport. The secondary trail kit is capable of converting the enclosed container to a trailer at a remote sight with a minimum of tools while still protecting the primary load.

### SUMMARY OF THE INVENTION

A field assemblable trailer, which is comprised of a container having a bottom, a hitch assembly configured to be securable to the bottom of the container, an axle housing configured to be securable to the bottom of the container, a pair of hub and axle assemblies configured to be attached inside the axle housing and a pair of tires on rims configured to attach to the hubs. The hitch assembly, the axle housing, the pair of hub and axle assemblies and the tires on rims comprise a kit which fits inside the container. The kit takes up a minimal room which leaves the container free to accept a larger primary load for safe keeping. When the container is opened the kit is readily identifiable and is capable of converting the shipping container to an enclosed trailer quickly with minimal tools. This can be done while providing protection of the primary load.

### BRIEF DESCRIPTION OF THE DRAWINGS

The foregoing will become more readily apparent by referring to the following detailed description and the appended drawings in which:

FIG. 1 is a perspective view of the field assemblable trailer with the component parts in an unassembled arrangement.

FIG. 2 is a perspective view of the field assemblable trailer that shows the container on the jack system.

FIG. 3 is a perspective view of the field assemblable trailer, showing the hitch assembly mounted to the bottom of the container.

FIG. 4 is a perspective view of the field assemblable trailer, showing the axle housing mounted to the bottom of the container.

FIG. 5 is a perspective view of the field assemblable trailer, showing the hub and axle assembly mounted in the axle housing.

FIG. 6 is a perspective view of the field assemblable trailer, showing the battery, wiring harness and light mounted to the field assemblable trailer.

FIG. 7 is a perspective view of the field assemblable trailer, showing the tires and rims mounted to the hub.

FIG. 8 is a perspective view of the field assemblable trailer fully assembled.

FIG. 9A schematic of one embodiment of primary package.

FIG. 9B schematic of one embodiment of primary package.

FIG. 10 is a perspective view of another embodiment of the field assemblable trailer fully assembled.

FIG. 11 is a perspective view of another embodiment of the field assemblable trailer, showing the hitch assembly mounted to the bottom of the container.

### DETAILED DESCRIPTION OF THE INVENTION

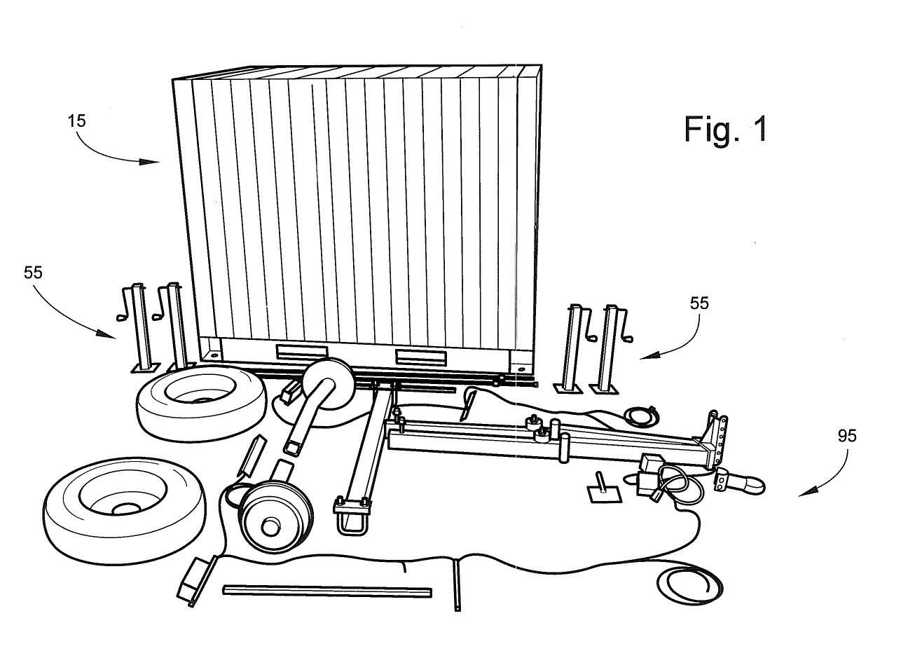

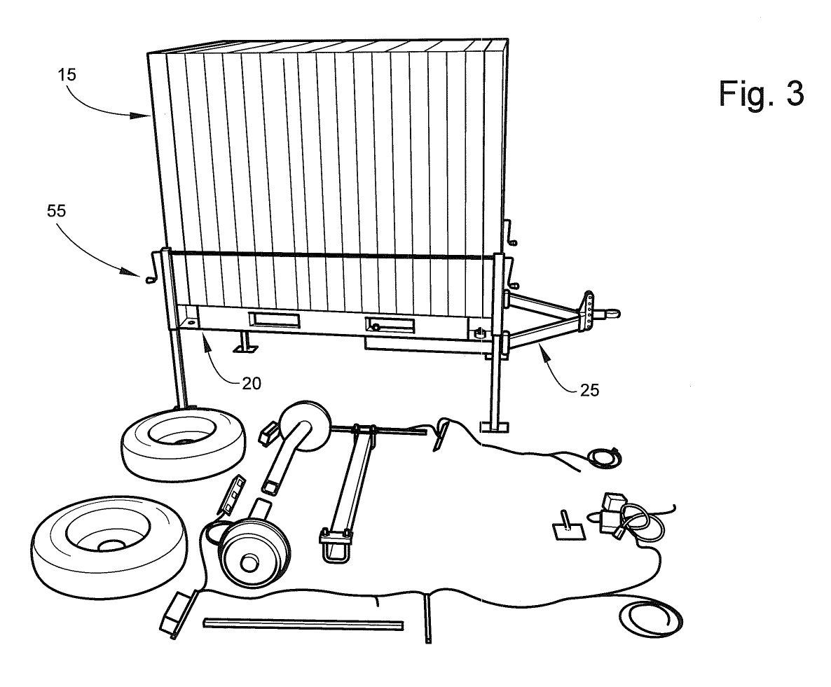

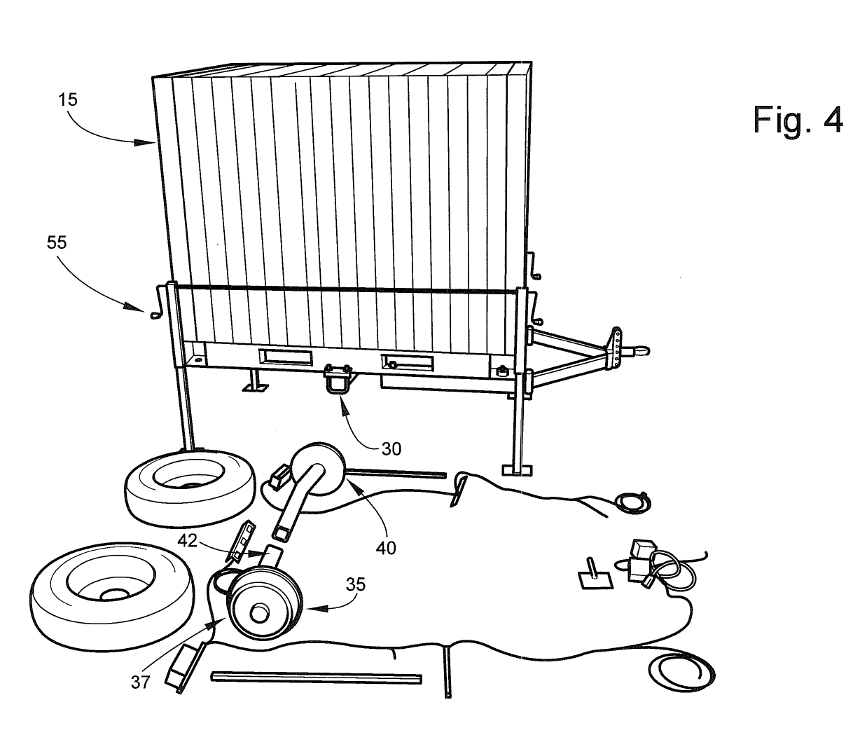

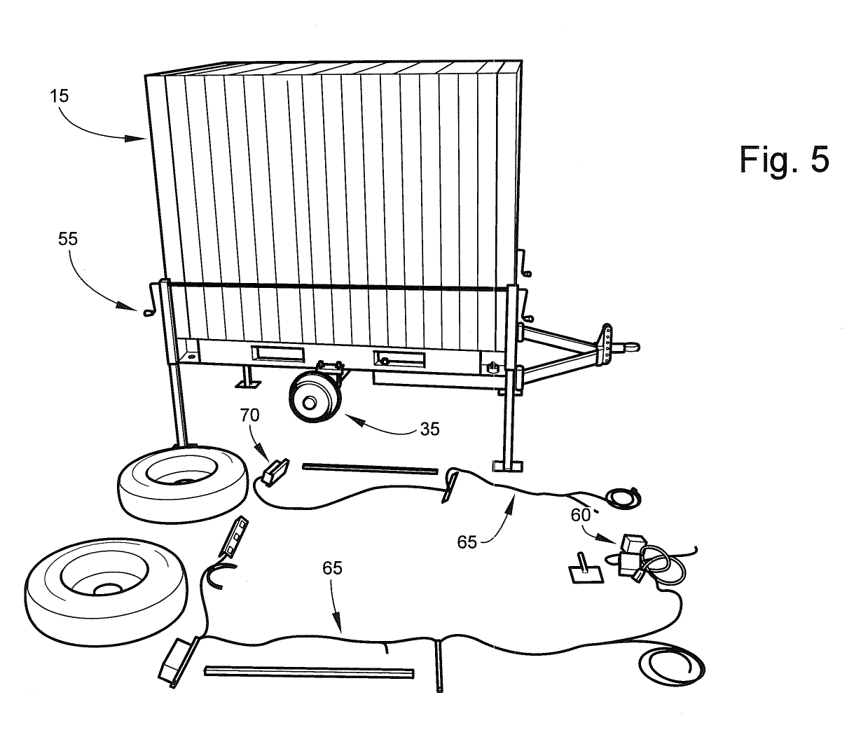

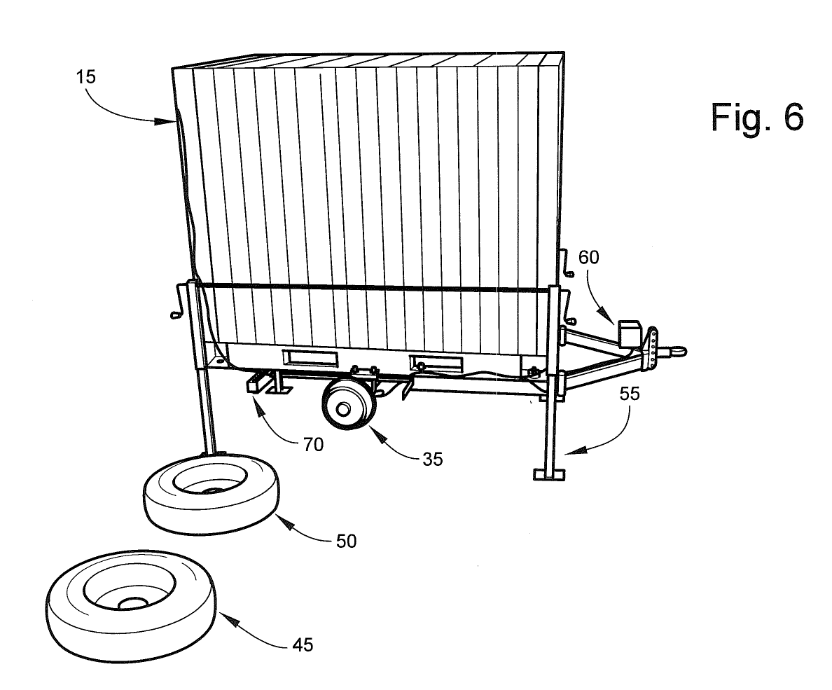

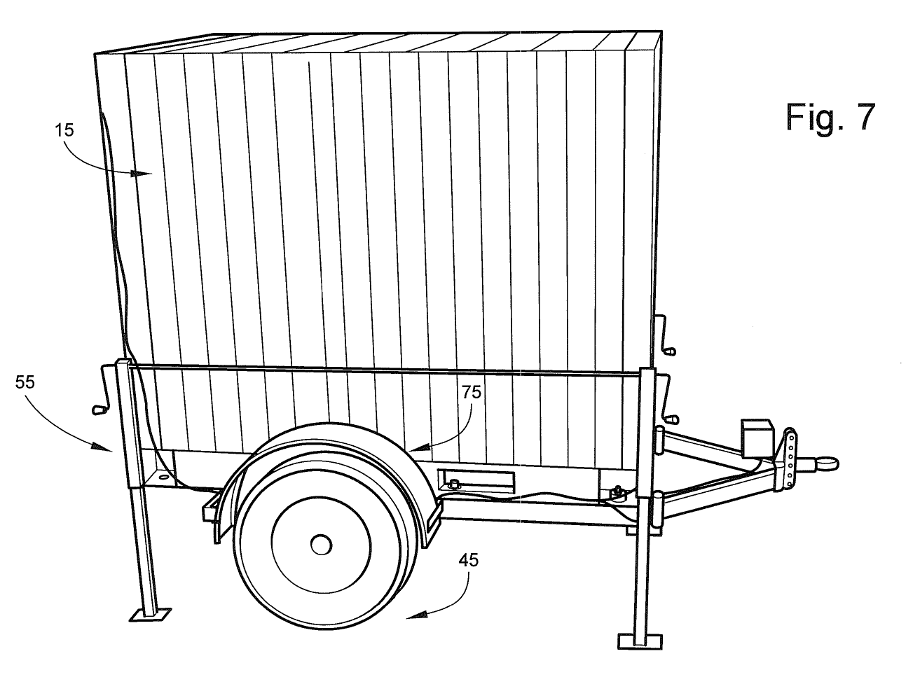

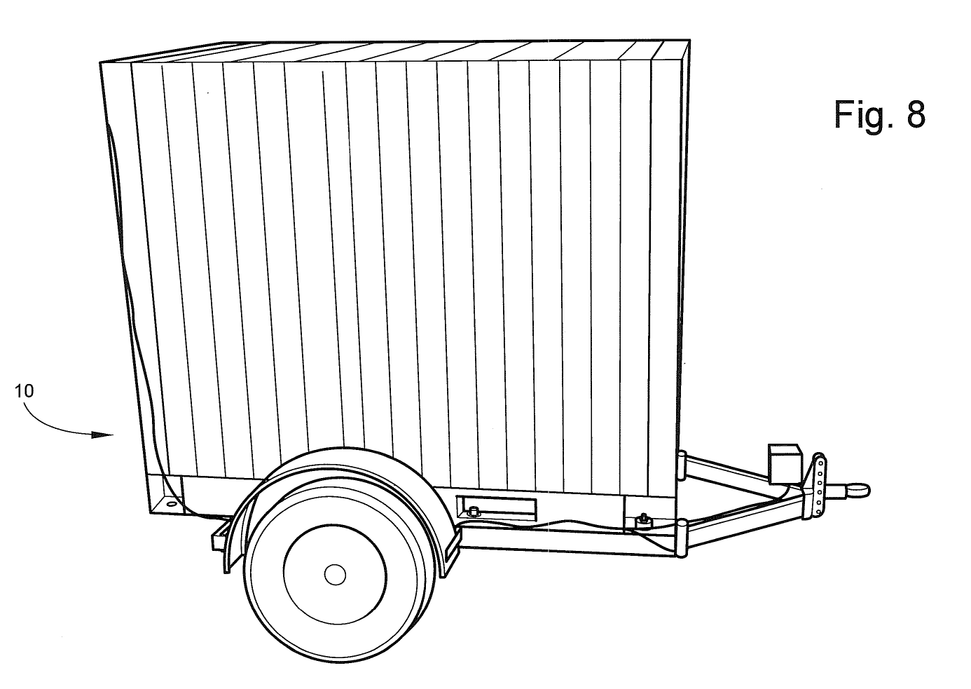

A field assemblable trailer 10, FIG. 8, which is comprised of a container 15, FIG. 1, having a bottom 20, a hitch assembly 25 configured to be securable to the bottom 20 of the container 15, FIG. 3, an axle housing 30 configured to be securable to the bottom 20 of the container 15, FIG. 4, a pair of hub (37) and axle (42) assemblies 35, 40 configured to be attached inside the axle housing 30, FIG. 6, and a pair of tires on rims 45, 50 configured to attached to the hubs 37, FIG. 7. The hitch assembly 25, the axle housing 30, the pair of hub and axle assemblies 35, 40 and the tires on rims 45, 50 all fit inside the container 15 and are capable of being assembled quickly with minimal tools.

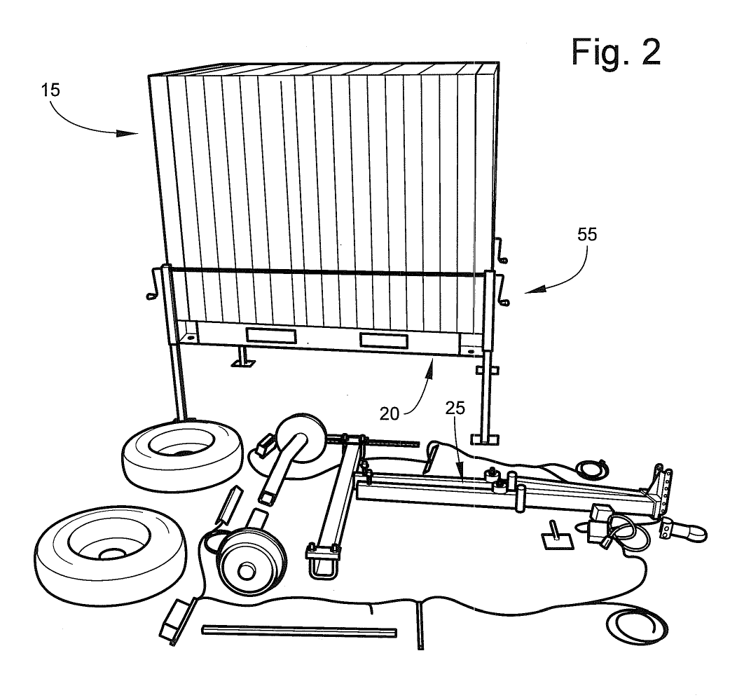

In one of the embodiments of the invention, the field assemblable trailer 10 includes a jack system 55, FIG. 1. The jack system connects to the container 15 and is used to raise the container 15 above the ground, FIG. 2, so that the other parts such as the hitch assembly 25, axle housing 30, the pair of hub and axle assemblies 35, 40 and tires and rims 45, 50, could all be affixed to the container 15. When the parts are attached and secured then the container can be lowered for use, FIG. 8, such as, but not limited to, attaching it to a tow vehicle.

In one of the embodiments of the invention, the field assemblable trailer 10 can be fitted with a lighting kit adapted to facilitate use on the road. The lighting kit is comprised of a battery 60, a wiring harness 65, and a light 70. Then the battery, the wiring harness, and the light can all be attached to the field assemblable trailer as shown in FIG. 6. It is also known in another embodiment where the lighting lit only includes a wiring harness and a light where the wiring harness may be connected to the electrical system of the tow vehicle.

In one of the embodiments of the invention the field assemblable trailer 10 can be fitted with a fender 75. The fender is adapted to be affixed to the container and over the tire as shown in FIG. 7.

In one of the embodiments of the invention, the container 15 of the field assemblable trailer 10 can be a standardized container which is adapted to be combinable with like units to facilitate shipping. The container 15 is preferably an intermodal, a modular intermodal, or a specialty container such as the containers being offered from Charleston Marine Containers Inc., of Charleston S.C. Examples of these containers include but are not limited to the Quadcon, the Tricon, and the Bicon. Other examples of intermodal containers are 20 or 40 foot shipping containers or other ISO (International Organization for Standardization) certified intermodal shipping container. The Quadcon container is configured to enable four containers to be secured together using an exclusive connector so that the resulting package has the same footprint as a standard 20 foot ISO intermodal container. Alternatively two Quadcons can be combined to make a 10 foot ISO container. With the Tricon, three containers have the same footprint as a standard 20 foot ISO intermodal container. With the Bicon, two containers have the same footprint as a standard 20 foot ISO intermodal container. Intermodal is defined as being or involving transportation by more than one form of carrier during a single journey.

The field assemblable trailer 10 in another embodiment is comprised of an enclosed standardized intermodal shipping container 15, hereinafter container. This container 15 has a bottom 20 and is capable of holding a primary package 90. There is a trailer kit 95, where the trailer kit 95 comprises a hitch assembly 25 configured to be securable to the bottom 20 of the container 15, an axle housing 30 configured to be secured to the bottom 20 of the container 15. The trailer kit 95 also contains a pair of hub and axle assemblies 35, 40 configured to be attached inside the axle housing 30, a pair of tires on rims 45, 50 configured to attach to the hub 37. The trailer kit 95 contains a jack system 55 where the jack system allows the container 15 to be raised so trailer kit 95 parts can be attached. The jack system 55 also allows the field assemblable trailer 10 to be lowered for removal after the components from the trailer kit 95 have been attached. The trailer kit 95 and the primary package 90 all fit inside the container 15 and are capable of being assembled quickly with minimal tools.

In one embodiment of the invention, the axle housing 30 of the field assemblable trailer 10 can be secured at different points along the bottom 20 of the container 15 to allow a user to better balance the container 15 and the primary package 90.

In another embodiment of the invention, the field assemblable trailer 10 may further comprise a battery 60, a wiring harness 65, and a light 70. The battery 60, wiring harness 65 and light 70 are all attached to the field assemblable trailer 10. Here the battery 60 can be used to power the light 70 on the field assemblable trailer 10 to increase visibility in lower light situations or at night.

The field assemblable trailer 10, in another embodiment, may further comprise a pair of fenders 75 adaptable to be affixed to the container 15 and over the tires 45, 50. If the field assemblable trailer 10 has been fitted with the light assembly then the light may be affixed to either the container 15 or the fenders 75. In another embodiment of the invention, a plurality of lights may be provided which attach to the wiring harness which in turn is connected to the battery for power or are connected to the tow vehicle's electrical system. This plurality of lights can be connected to the container 15 or over the fenders 75.

In another embodiment of the invention, the container 15 may be selected from the group consisting of: Quadcon, Tricon, and Bicon containers. In another embodiment of the invention, the trailer kit 95 is clearly marked and bundled together so that the trailer kit 95 can be unloaded without having to move the primary package 90.

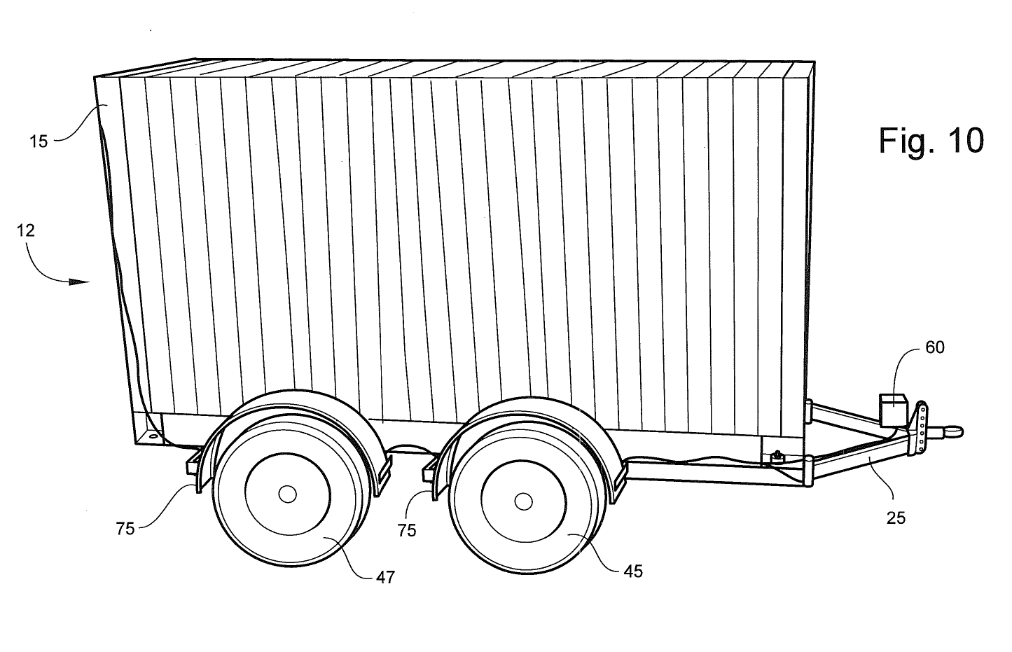

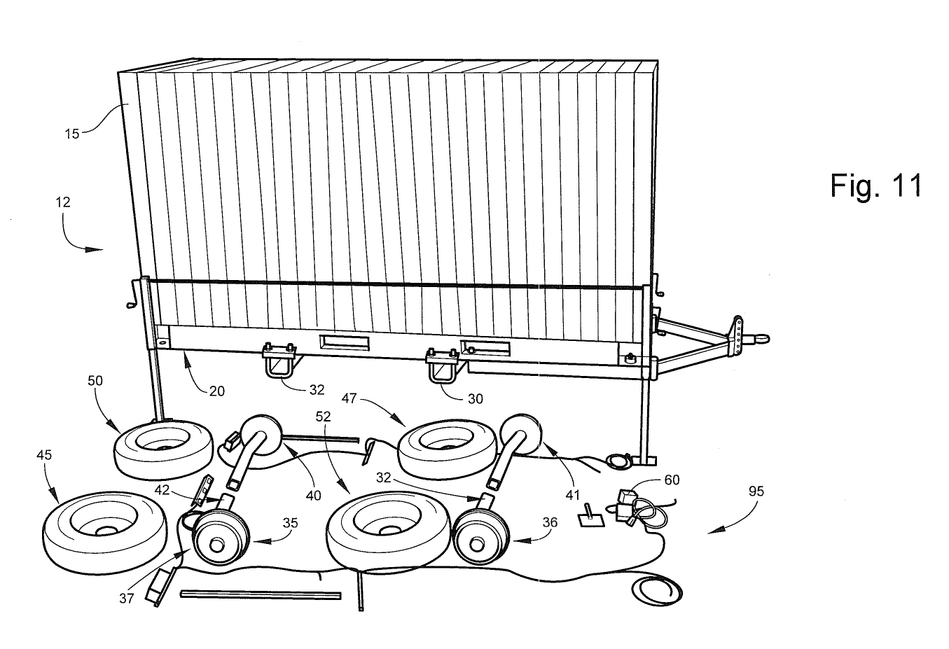

In another embodiment of the invention, the field assemblable trailer 12, FIG. 10, where the trailer kit 95 is further comprised of a second axle housing 32, FIG. 11, configured to be secured to the bottom 20 of the container 15, a second pair of hub and axle assemblies 36, 41 configured to be attached inside the axle housing 32 and a second pair of tires on a second pair of rims 47, 52 configured to attached to the hub and axle assemblies 36, 41. In this embodiment the field assemblable trailer 12, FIG. 10 has four tires connected by two axles to allow for primary packages of greater weight. This embodiment may also be used when the container is larger, such as with a Tricon or a Bicon container. Most of the trailer kit is assembled using bolts, nuts and washers. However other removable, securable means for attachment can be used, including but not limited to, cotter pins and wing nuts. It would also be known to secure these parts by welding or with adhesive however these means would not allow these parts to easily be removed for later intermodal shipment.

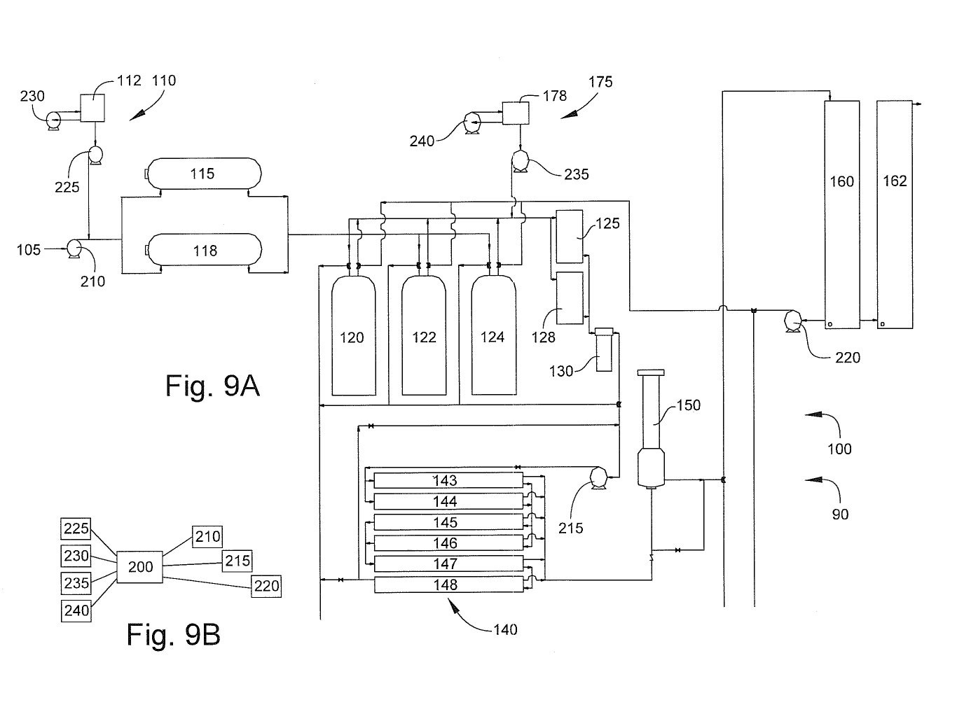

The primary package 90, in one of the embodiments, is a water treatment system 100. This water treatment system 100 may be the water treatment system taught in U.S. Pat. No. 6,936,176, which is incorporated herein by reference. The water treatment system 100, FIG. 9A, in another embodiment may comprise a water inlet 105, an alum feed 110 connected to the water inlet 105, an alum feed retaining tank 115 connected to the alum feed 110 and a regenerable filter 120 connected to the alum feed retaining tank 115. The regenerable filter 120 is configured to receive water that has flown through the inlet 105. This regenerable filter 120 can separate solids from water flowing through it. The regenerable filter 120 comprises one or more layers of fine particulates on a bed of coarse particulates. The fine particulates may include, but are not limited to, a layer of anthracite having an average particle size of between 0.5 and 1.5 millimeter in diameter, a layer of garnet having an average particle size between or equal to 425 to 600 micrometers, and a layer of support material where the support material is selected from the group consisting of coarse garnet or gravel having an average particle size of between 1.8 to 5 micrometers. The regenerable filter 120 is connected to an ultraviolet sterilization unit 125 which is connected to a cartridge filter 130. A reverse osmosis system 140 is provided which is connected to the cartridge filter 130. The reverse osmosis system 140 is connected to an erosion chlorinator 150. An example of an erosion chlorinator is taught in U.S. Pat. No. 5,089,127 or Applicant's co-pending application publication number US 2006/0191833 the teachings of which are incorporated herein by reference. The erosion chlorinator 150 is connected to a clean water tank 160.

In another embodiment of the invention, the field assemblable trailer 10 and the water treatment system 100 further comprise a generator 200, FIG. 9B and a series of electric pumps 210, 215, 220 connected to the generator that send water to be treated through the water treatment system. The electric pump 210 brings water through the inlet. Electric pump 215 pulls water from the cartridge filter 130 to the reverse osmosis system 140. Electric pump 220 pulls water from the clean water tank 160 to either clean the regenerable filter 120, or to send the clean water to an end use. The generator 200 may be a gasoline, diesel, propane, or natural gas generator. The generator 200 may also be powered by renewable resources such as solar, wind, or hydro-electric power sources.

In another embodiment of the invention, the water treatment system 100, FIG. 9A, has an alum feed 110 that comprise an alum feed tank 112 which is attached to an alum recirculation pump 230. The alum recirculation pump is powered by the generator 200. The alum treatment is dispersed from the alum feed tank 112 by an alum feed pump 225. This alum feed pump 225 is powered by the generator 200, FIG. 9B. Alum is available in either a powder or granular form that is mixed into a solution ranging from 5 to 10% by weight of alum to water.

In another embodiment of the invention, the water treatment system 100 may further comprise an anti-scaling feed 175. In another embodiment of the invention the anti-scaling feed 175 may comprise an anti-scaling feed tank 178 which is attached to an anti-scaling recirculation pump 240. The anti-scaling recirculation pump 240 is powered by the generator 200. The anti-scaling treatment is dispersed from the anti-scaling feed tank 178 by an anti-scaling feed pump 235. This anti-scaling feed pump 235 is powered by the generator 200, FIG. 9B.

The regenerable filter 120 of the embodiment where the primary package 90 is a water treatment system 100 is configured so that the filter can use clean water from the clean water tank 160 to backwash the regenerable filter 120 so that it will be effective in removing particulates from the water source. Generally the backwash will be performed until the water running through the regenerable filter 120 is clear. In another embodiment of the invention one might want to use a plurality of regenerable filters 120, 122, 124 so that one filter can be backwashed while one or more of the other filters is used to remove particulated contaminants. In one of the embodiments of the invention a clean water pump 220 is used to send water from the clean water tank 160 back through the filter for the backwash operation.

The primary package 90, in another embodiment of the invention, has a water treatment system 100, FIG. 9A, that comprise a water inlet 105, which draws the water using inlet pump 210 and an alum feed 110 connected to the water inlet 105. Then a pair of alum feed retaining tanks 115, 118 are provided. Alum feed retaining tanks 115, 118 are in communication with the alum feed 110. Three regenerable filters 120, 122, 124 are connected to the alum feed retaining tanks 115 and 118. The regenerable filters 120, 122 and 124 are configured to receive water that has flown through the inlet 105. These regenerable filters can separate solids from water flowing through it. The regenerable filters comprise one or more layers of fine particulates on a bed of coarse particulates. The fine particulates may be, but are not limited to, a layer of anthracite having an average particle size of between 0.5 and 1.5 millimeter in diameter, a layer of garnet having an average particle size between or equal to 425 to 600 micrometers and a layer of support material where support material is selected from the group consisting of coarse garnet or gravel having an average particle size of between 1.8 to 5 micrometers. The regenerable filters 120, 122 and 124 are connected to a pair of ultraviolet sterilization units 125, 128 which are connected to a cartridge filter 130. A reverse osmosis system 140 is provided which is connected to the cartridge filter 130. The reverse osmosis system 140 can be made up multiple reverse osmosis filter elements 143, 144, 145, 146, 147 and 148. In order to facilitate flow through the reverse osmosis system 140 a reverse osmosis pump 215 is provided between the cartridge filter 130 and the reverse osmosis system 140. The reverse osmosis system 140 is connected to an erosion chlorinator 150. The erosion chlorinator 150 is connected to a pair of clean water tanks 160 and 162. A clean water pump 220 is connected to the clean water tanks 160 and 162 and can be used to either, backwash the regenerable filters 120, 122 and 124, or to supply clean water to a designated location. In this example the inlet pump 210 the reverse osmosis pump 215 and clean water pump 220 are all connected and powered from an electrical generator 200.

In another embodiment of the invention the primary package 90 may be any materials that one whishes to protect and wants to transport to a location. Examples include but are not limited to food supplies, medical supplies, building supplies, clothing, temporary shelter, laboratory equipment, test equipment, ammunition, weapons or any load that is desired to protect from the elements or to be protected while shipped.

The invention allows the entire trailer kit 95 to fit into the standardized container 15, which are combinable for shipping reason. It can then be removed and assembled with a minimum of tools and people so that it could be attached to a tow vehicle and used as a trailer 10. When the trailer 10 is no longer required, the trailer kit 95 components can be easily disassembled and loaded back into the container for transport to another location. It has be found that with use of the field assemblable trailer 10, using a Quadcon container that two people with minimal hand tools can assemble or disassemble the field assemblable trailer 10 in under an hour.

The present invention also provides a method of assembling a trailer 10, which is comprised of the steps of providing an enclosed standardized intermodal shipping container 15, hereinafter container. This container 15 has a bottom 20 and is capable of holding a primary package 90. A trailer kit 95 is also provided. The trailer kit 95 is comprised of a hitch assembly 25, an axle housing 30, a pair of hub and axle assemblies 35, 40, a pair of tires on rims 45, 50, and a jack system 55. This trailer kit 95 comes loaded in the container 15. The trailer kit 95 is removed from the container 15. The jack system 55 is placed at each corner of the container 15. Then the container 15 is raised by the jack system 55. Once the container is raised off the ground, the hitch assembly can then be attached to the bottom 20 of the container 15. The axle housing 30 is then attached to the bottom 20 of the container 15. Hub and axle assemblies 35, 40 can then be affixed within the axle housing. Then the pair of tires on rims 45, 50 can be attached to the hub an axle assemblies 35, 40 to create a trailer 10. The trailer 10 is then lowered and the jack system 55 is removed. All the trailer components were attached using minimal hand tools.

### EXAMPLES

An example of this invention will soon be available from Water Missions International of Charleston S.C. under the trademark RAPID RESPONSE. In this example the trailer is a completely self-contained unit which holds both a primary package and the trailer kit 95. The intermodal container is a Quadcon, which serves as a shipping container and a permanent securable housing for all the processing equipment (primary package). Quick leveling jack assemblies make up the jack system 55. The jack system 55 attaches to each corner of the Quadcon container 15 and elevate the container off the ground. Once elevated, the axle, wheels, and trailer hitch assembly, stored in the Quadcon during shipping, can be attached in the field without special equipment or tools. The Quadcon with the trailer kit 95 packed inside, allows for containerized shipment by ground, sea or air (intermodal transport). Once the Quadcon is transformed into a trailer, it can be towed to remote locations. The field set up of the trailer can be accomplished in just one hour.

In this example the primary package is a water treatment system. This system is capable of producing 10 gallons per minute of safe potable water from most water sources up to approximately 15,000 ppm of dissolved solids (i.e. brackish water). A similar system is designed to treat water sources containing more than 15,000 ppm (parts per million) of dissolved solids, up to sea water (approximately 35,000 ppm). This system provides process control options for generator startup, process flow controls, and treated water quality monitoring. These controls can either be manual or touch-screen microprocessor control. Power is provided by a 20 kW (kilowatt) diesel power generator, which provides power for pumps, electronics, and lighting. A submersible pump is designed to transfer raw water from any source to the water treatment system. 100 feet (about 30 meters) of raw water hose allows the system to be placed up to 100 feet (about 30 meters) from the water source. Three backwashable filters remove 99.9% of the suspended particulates down to approximately 3 microns. The treated water from the filter stage is typically less than 1 NTU (nephlometric turbidity units). Reverse osmosis stage 140 removes dissolved inorganic and organic contaminants. Treated water from the reverse osmosis stage meets USEPA National Primary and Secondary Water Regulations. With this example, the water treatment system can be set up in less than an hour.

What is claimed is:

1. A field assemblable trailer comprising:
an enclosed standardized intermodal shipping container, hereinafter container, said container has a bottom and is capable of holding a primary package; and
a trailer kit, where said trailer kit comprises:
a hitch assembly configured to be securable to said bottom of said container;
an axle housing configured to be securable to said bottom of said container;
a pair of hub and axle assemblies configured to be attached inside said axle housing;
a pair of tires on rims configured to attach to said hub and axle assemblies;
a jack system where said jack system allows said container to be raised
and lowered so components of said trailer kit can be attached; and
where said trailer kit and said primary package fit inside the container and are capable of being assembled quickly with minimal tools.

2. The field assemblable trailer according to claim 1 where said axle housing can be secured at different points to allow said primary package to be better balanced within said container.

3. The field assemblable trailer according to claim 1 further comprising:
a battery;
a wiring harness;
a light; and
where said battery, said wiring harness and said light can all be attached to said field assemblable trailer.

4. The field assemblable trailer according to claim 1 further comprising a pair of fenders adaptable to be affixed to the container and over the pair of tires.

5. The field assemblable trailer according to claim 1 where the container is selected from the group consisting of: Quadcon, Tricon and Bicon containers.

6. The field assemblable trailer according to claim 1 where said trailer kit is clearly marked and can be unloaded without having to move said primary package.

7. The field assemblable trailer according to claim 1 where said trailer kit further comprises:
a second axle housing configured to be securable to said bottom of said container;
a second pair of hub and axle assemblies configured to be attached inside said axle housing;
a second pair of tires on a second pair of rims configured to attached to said hub and axle assemblies; and
where said field assemblable trailer has four tires connected by two axles to allowing for primary packages of greater weight.

8. The field assemblable trailer according to claim 1 where said primary package is a water treatment system comprising:
a water inlet;
an alum feed connected to said water inlet;
an alum feed retaining tank connected to said alum feed;
a regenerable filter connected to said alum feed retaining tank so as to receive water that has flown through said water inlet, said regenerable filter configured to separate solids from water flowing therethrough, said regenerable filter comprises one or more layers of fine particulates on a bed of coarse particulates;
an ultraviolet sterilization unit connected to the regenerable filter;
a cartridge filter connected to said ultraviolet sterilization unit;
a reverse osmosis system connected to said cartridge filter;
an erosion chlorinator connected to said reverse osmosis system; and
a clean water tank connected to said erosion chlorinator.

9. The field assemblable trailer according to claim 8 where said water treatment system further comprises:
a generator; and
a series of electric pumps connected to said generator which sends water to be treated through said water treatment system.

10. A field assemblable trailer comprising:
an enclosed standardized intermodal shipping container, hereinafter container, said container has a bottom and is capable of holding a primary package; and
a trailer kit, where said trailer kit comprises:
a hitch assembly configured to be securable to said bottom of said container;
an axle housing configured to be securable to said bottom of said container;
a pair of hub and axle assemblies configured to be attached inside said axle housing;
a pair of tires on rims configured to attach to said hub and axle assemblies;
a jack system where said jack system allows said container to be raised so components of said trailer kit can be attached; and
where said trailer kit and said primary package fit inside the container and are capable of being assembled quickly with minimal tools; and
where said primary package is a water treatment system comprising:
a water inlet;
an alum feed connected to said water inlet;
an alum feed retaining tank connected to said alum feed;
a regenerable filter connected to said alum feed retaining tank so as to receive water that has flown through said water inlet, said regenerable filter configured to separate solids from water flowing therethrough, said regenerable filter comprises one or more layers of fine particulates on a bed of coarse particulates;
an ultraviolet sterilization unit connected to the regenerable filter;
a cartridge filter connected to said ultraviolet sterilization unit;
a reverse osmosis system connected to said cartridge filter;
an erosion chlorinator connected to said reverse osmosis system; and
a clean water tank connected to said erosion chlorinator.

11. The field assemblable trailer according to claim 10 where said axle housing can be secured at different points to allow said primary package to be better balanced within said container.

12. The field assemblable trailer according to claim 10 further comprising:
a battery;
a wiring harness;
a light; and
where said battery, said wiring harness and said light can all be attached to said field assemblable trailer.

13. The field assemblable trailer according to claim 10 further comprising a pair of fenders adaptable to be affixed to the container and over the pair of tires.

14. The field assemblable trailer according to claim 10 where the container is selected from the group consisting of: Quadcon, Tricon and Bicon containers.

15. The field assemblable trailer according to claim 10 where said trailer kit is clearly marked and can be unloaded without having to move said primary package.

16. The field assemblable trailer according to claim 10 where said trailer kit further comprises:
a second axle housing configured to be securable to said bottom of said container;
a second pair of hub and axle assemblies configured to be attached inside said axle housing;
a second pair of tires on a second pair of rims configured to attached to said hub and axle assemblies; and
where said field assemblable trailer has four tires connected by two axles to allowing for primary packages of greater weight.

17. The field assemblable trailer according to claim 10 where said water treatment system further comprises:
a generator; and
a series of electric pumps run by said generator which sends water to be treated through said water treatment system.

18. A method of assembling a trailer in a field comprising the steps of:
providing an enclosed standardized intermodal shipping container, hereinafter container, said container has a bottom and is capable of holding a primary package;
providing a trailer kit, where said trailer kit comprises: a hitch assembly, an axle housing, a pair of hub and axle assemblies, a pair of tires on rims, and a jack system where said trailer kit is loaded in said container;
removing said trailer kit from said container;
placing said jack system at each corner of said container;
raising said container with said jack system;
attaching said hitch assembly to said bottom of said container;
attaching said axle housing to said bottom of said container;
affixing said hub and axle assemblies within said axle housing;
attaching said pair of tires on rims to said hub and axle assemblies to create said trailer; and
lowering said trailer and removing said jack system where all components of said trailer lit were attached using minimal hand tools.
